(19) United States
(12) Patent Application Publication
(10) Pub. No.: US 2007/0050150 A1
(43) Pub. Date: Mar. 1, 2007

(54) System and method for positively changing mood through electronic media

(76) Inventors: Jeffrey S. Levy, Newton Square, PA (US); Martin Seligman, Wynnewood, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/485,689

(22) Filed: Jul. 13, 2006

Related U.S. Application Data
(60) Provisional application No. 60/698,778, filed on Jul. 13, 2005.

(51) Int. Cl. G06F 19/00

(52) U.S. Cl. 702/19

(57) ABSTRACT

Provided are a system and method for positively changing a user's mood including a computer-implemented interactive graphical user-interface (GUI) for delivering positive psychology/cognitive therapy (PPCT) content according to user responses to mood and signature strength assessing tools. The PPCT content can include automated interventions and interactive interventions with a partner.

### CROSS REFERENCE TO RELATED APPLICATIONS

Reference is made to and priority claimed from U.S. Provisional Application No. 60/698,778, filed Jul. 13, 2005, which is incorporated herein by reference.

### BACKGROUND

People have long pondered the question “How can we become lastingly happier?” However, until recently, the predominant guiding question in clinical psychology and psychiatry has been “How can we reduce suffering?” People are not made content simply by being less depressed, less anxious and less angry. Happiness must also be enhanced.

In accordance with prior art practices, most of the time, depression can be markedly shortened in duration and considerably relieved in intensity by treatment. Current practices rely on numerous therapies to treat depression. Included in such therapies are two that are biological and two that are psychological. Clinically, these therapies have proven to be equally effective and can be said to treat depression moderately well.

Specifically, the two biological treatments can include drugs and electroconvulsive shock (ECS). The two psychological therapies can include Interpersonal Therapy (IPT) and Cognitive Therapy (CT). The main kinds of drugs that can be used are tricyclics (brand names: “Elavil,” “Tofranil,” and “Sinequan”), MAO-inhibitors (“Marplan,” “Nardil,” and “Pamate”), and serotonin reuptake inhibitors (“Prozac” “Zoloft”). Generally, these drugs take between two to six weeks to start working. When administered properly clinical tests indicate that these exemplary drugs can relieve depression around sixty five percent of the time.

Although clinically effective, depressed patients, around twenty-five percent of all depressed people, cannot or will not submit themselves to a prescription treatment plan. There are several reasons why prescription therapy is not chosen for treatment including the potential physiological/psychological side effects experienced from anti-depressant drugs (e.g., sexual dysfunction, hypertension, and lack of motivation) and the considerable risk (almost the same risk as without prescription therapy) for relapse or recurrence of depression once a depressed person stops taking the anti-depressant drugs. As such, in order to prevent further depression or not to relapse, current prescription therapy practices call for continuous intake of anti-depressants for as much as the remaining life duration of a depressed person.

Another biological treatment is ECS therapy. Clinically, ECS therapy has proven to be highly effective as it can relieve depression in around seventy five percent of patients (particularly effective on suicidal patients). In practice, ECS treatment can be administered in several sessions spread out over a selected time period (e.g., a session a day for 4 days). However, ECS is not without side effects that include physical and psychological side effects (memory loss, cardiovascular changes, confusion, and cost). Moreover, ECS therapy has various social stigmas attached to it as a treatment for depression. As such, depressed patients will often not voluntarily choose such treatment, but rather wait until it is prescribed by a depressed person's physician (or psychiatrist). Also, akin to drug therapy, there is no evidence that ECS therapy reduces the recurrence of depression in depressed people. Rather, clinical studies have only shown that ECS therapy often provides relief from acute depression.

Comparatively, there are a number of psychological treatments for depression (or to alter mood generally). Cognitive therapy seeks to change the conscious thinking of a depressed patient regarding failure, defeat, loss, and helplessness. In practice, there are a number of basic tactics that are deployed in cognitive therapy. These tactics rely on assisting the patient to learn a number of exercises to combat an onset of a mood swing (e.g., depression). Such tactics include, but are not limited to: 1) learning automatic thoughts—automatic thoughts are very quick phrases, so well practiced as to be almost unnoticed and unchallenged; 2) learning to dispute automatic thoughts by focusing on contrary evidence; 3) learning to make different explanations for behavior called “reattributions”; 4) learning to distract oneself from depressing thoughts; and 5) learning to question the depression-sowing assumptions governing the patient's actions.

Clinical studies have shown that cognitive therapy is effective, bringing relief to about 70 percent of depressed people. On a quantitative analysis, cognitive therapy is as effective as prescription therapy, but is less effective than ECS treatment. Cognitive therapy, however, can take up to a month before beneficial effects are realized. In practice the cognitive therapy is brief usually totaling a few months in duration where the patient is treated once or twice a week. With cognitive therapy, unlike prescription therapy or ECS, there is a lower risk of recurring depression as the patient is taught new skills of thinking that can be reapplied when the patient begins to experience future mood changes (e.g., depression). However, cognitive therapy does not lower the risk of recurrence to zero.

Although effective, cognitive therapy has several limitations. First, cognitive therapy can work better on moderate depression than on really severe depression. Second, cognitive therapy has mostly been used with educated people who are “psychologically-minded”—aware of their thoughts and how thinking affects their emotions. There is little clinical evidence to show how well it works in less educated and less sophisticated people. Third, there is so much recurrence of severe depression, even with cognitive therapy, that there is a long way to go before anything more than “moderate relief” can be claimed.

Another psychological treatment is interpersonal therapy (IPT). Generally, IPT focuses on social relations as a manner of affecting a person's mood. IPT sees depression in a medical model: depression has many causes, biological as well as environmental. Salient among the causes are interpersonal problems. IPT hones in on the here and now problems of getting along with other people. Current disputes, frustrations, anxieties, and disappointments are the main material of therapy. IPT looks at four problem areas in the current life of the patient: grief, fights, role transitions, and social deficits.

The main virtues of this approach is that it is brief and inexpensive (a few months), it has no known bad side effects, and it has been shown to be quite effective against depression, bringing relief in around 70 percent of cases. IPT's significant drawback is that it has not become very widely practiced. This means that little research has been done to find its active ingredients and to replicate its benefits in depression. This also means it is hard to find an IPT therapist, rendering IPT marginally effective on a large geographic disparate population.

Positive Psychology

Positive psychology is an umbrella term for the study of positive emotions, positive character traits, and enabling institutions. Research findings from positive psychology are intended to supplement, not to replace, what is known about human suffering, weakness, and disorder. The intent is to have a more complete and balanced scientific understanding of the human experience—the peaks, the valleys, and everything in between. A complete science and a complete practice of psychology should include an understanding of both suffering and happiness, as well as their interaction, and validated interventions that both relieve suffering and increase happiness—two separable endeavors.

The book Character Strengths and Virtues: A Handbook and Classification (Peterson & Seligman, 2004) (CSV) was written from the perspective of positive psychology. It was intended to do for psychological well-being what the Diagnostic and Statistical Manual of Mental Disorders (American Psychiatric Association, 1994) (DSM) does for the psychological disorders that disable human beings. The CSV describes and classifies strengths and virtues that enable human thriving. Although the authors were respectful of the DSM, they also attempted to avoid some of its problems by making clear why some entries were included in the CSV and others excluded, by regarding positive traits as individual differences that exist in degrees rather than as all-or-nothing categories, and by developing reliable and valid assessment strategies (questionnaires, surveys, interviews, and informant reports; Peterson, Park, & Seligman, 2005a).

The general scheme of the CSV relies on six overarching virtues that almost every culture across the world endorses: wisdom, courage, humanity, justice, temperance, and transcendence (Dahlsgaard, Peterson, & Seligman). Under each virtue, particular strengths were identified that met the following criteria:

ubiquity—is widely recognized across cultures;

fulfilling—contributes to individual fulfillment, satisfaction, and happiness broadly construed;

morally valued—is valued in its own right and not as a means to an end;

does not diminish others—elevates others who witness it, producing admiration, not jealousy;

nonfelicitous opposite—has obvious antonyms that are “negative”;

traitlike—is an individual difference with demonstrable generality and stability;

measurable—has been successfully measured by researchers as an individual difference;

distinctiveness—is not redundant (conceptually or empirically) with other character strengths;

paragons—is strikingly embodied in some individuals;

prodigies—is precociously shown by some children or youths;

selective absence—is missing altogether in some individuals; and

institutions—is the deliberate target of societal practices and rituals that try to cultivate it.

The Table of FIGS. 1A and 1B sets forth the classifications, which includes 24 strengths of character.

Each chapter in the CSV describes what is known and what is not known about each of the included strengths: paradigm cases, consensual definition, historical and cross-cultural background, measurement, correlations and consequences of having or lacking the strength, development, enabling and disabling conditions, gender differences, and interventions that build the strength. The CSV was intended to be a framework for conducting research and creating new interventions.

Research along these lines has revealed at least three surprising empirical findings. First, a remarkable similarity is apparent in the relative endorsement of the 24 character strengths by adults around the world and within the United States (Park, Peterson, & Seligman, 2005a). The most commonly endorsed (“most like me”) strengths, in 40 different countries, from Azerbaijan to Venezuela, are kindness, fairness, authenticity, gratitude, and open-mindedness, and the lesser strengths consistently include prudence, modesty, and self-regulation. The correlations of the rankings from nation to nation are very strong, ranging in the 80s, and defy cultural, ethnic, and religious differences. The same ranking of greater versus lesser strengths characterizes all 50 U.S. states—except for religiousness, which is somewhat more evident in the South—and holds across gender, age, red versus blue states, and education. Results may reveal something about universal human nature and/or the character requirements minimally needed for a viable society (cf. Bok, 1995).

Second, a comparison of the strengths profiles of U.S. adults and U.S. adolescents revealed overall agreement on ranking, yet a noticeably lower agreement than that found between U.S. adults and adults in any other nation studied (Park, Peterson, & Seligman, 2005b). Hope, teamwork, and zest were more common among U.S. youths than U.S. adults, whereas appreciation of beauty, authenticity, leadership, and open-mindedness were more common among adults. As attention is turned to the deliberate cultivation of character strengths, it is important to keep certain strengths from eroding on the journey to adulthood as new strengths are built from scratch (Park & Peterson).

Third, although part of the definition of a character strength is that it contributes to fulfillment, strengths “of the heart”—zest, gratitude, hope, and love—are more robustly associated with life satisfaction than are the more cerebral strengths, such as curiosity and love of learning (Park, Peterson, & Seligman, 2004). This pattern is apparent among adults and among youths as well as longitudinal evidence that these “heart” strengths foreshadow subsequent life satisfaction (Park et al., 2005b). One more finding to note: Self-regulation among parents, although not strongly associated with parental life satisfaction, is positively linked to the life satisfaction of their children (Park & Peterson).

Happiness and Interventions

It has been demonstrated that psychological interventions can lead to an increase in individual happiness. Happiness itself can be considered to comprise at least three distinct components (Seligman, 2002): (a) positive emotion and pleasure (the pleasant life); (b) engagement (the engaged life); and (c) meaning (the meaningful life). Recent research indicates that people's happiness reliably differs according to the type of life that they pursue and, further, that the most satisfied people are those who orient their pursuits toward all three of these components, with the greatest weight carried by engagement and meaning (Peterson, Park, & Seligman, 2005b). As used hereinafter, the word “happiness” is used in an atheoretical sense of labeling the overall aim of the positive psychology endeavor, and refers jointly to positive emotion, engagement, and meaning.

One nonobvious reason to be interested in interventions that build happiness is that happiness is not an epiphenomenon. An important fact that has emerged in the last few years is that happiness is causal, and it brings many more benefits than just feeling good. Recent research indicates that happy people are healthier, more successful, and more socially engaged than unhappy people, and the causal direction runs both ways (Lyubomirsky, King, & Diener). Much current research focuses on developing and evaluating interventions that build happiness.

From the foregoing it is appreciated the there is a need for an alternative therapy to alter mood (e.g., to ameliorate depression and/or to enhance happiness) that enhances the affects of existing practices and that can be a stand alone therapy that overcomes the shortcomings of existing practices.

### SUMMARY

The herein described systems and methods provide a computer-implemented interactive system and methods for positively changing mood and that enhances the effects of existing practices used to alter mood, such as drug therapy, and can also be used as a stand alone therapy. A graphical user-interface is provided to deliver interactive positive psychology and/or cognitive therapy (PPCT) core content to participating users. The interactive PPCT core content comprises a knowledge base that assists in positively altering mood and can include interventions such as happiness building activities.

In an illustrative embodiment, user mood and/or strengths are assessed, and PPCT core content can be delivered automatically by the system, such as via the graphical user interface, based on the assessed user mood and/or strengths. In another illustrative embodiment, the PPCT core content is delivered to the user in conjunction with a partner, such as a therapist or counselor, according to the mood and/or strength indicating criteria. In yet another embodiment, one or more icons can be provided on the graphical user interface, each icon corresponding to a potential partner for the user. The potential partners can correspond, for example, to a coach, an expert, a business professional, an employee, a supervisor, a military officer, or a consumer. The potential partner can correspond to a virtual partner, or to a person that the user interacts with remotely in real time. The user selects one of the potential partners by clicking on an icon, for example, to assist the user with respect to understanding the PPCT core content.

In an illustrative embodiment, the selected partner can have past experiences, characteristics, or is in a position that causes the user to identify with the partner with respect to the PPCT core content. In response to the selection of the icon by the user, content from the selected partner can be delivered to the user, such as content which corresponds to the views or experiences of the selected partner with respect to the PPCT core content, and may provide information to reinforce the PPCT core content.

The delivered content can comprise staged delivery of various components of positive psychology content including, but not limited to, interventions (e.g., exercises to facilitate self awareness and/or positive thinking), newsletters about mood and treating mood, interactive questions and answers, assessment questionnaires, positive psychology exercises, and book/movie recommendations (e.g., social science and fiction book recommendations).

Additional features, objects and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

The interactive systems and methods for positively changing mood via electronic media are further described with reference to the accompanying drawings in which:

FIGS. 1A and 1B are a Table of character strengths;

FIG. 2 is a Table showing the results of a study of the effects of Positive Psychology exercises on depression scores across time;

FIG. 3 is a graph showing changes in depression by Positive Psychology Therapy (PPT) intervention in cases of mild to moderate depressive symptoms.

FIG. 4 is a graph of the effectiveness of Positive Psychology Therapy (PPT) compared to conventional therapies;

FIG. 5 is a block diagram of an exemplary computing environment in accordance with an implementation of the herein described systems and methods;

FIG. 6 is a block diagram showing the cooperation of exemplary components of an illustrative implementation in accordance with the herein described systems and methods;

FIG. 7 is a block diagram showing the cooperation of exemplary components of another illustrative implementation in accordance with the herein described systems and methods;

FIG. 8 is a block diagram showing an illustrative block representation of an illustrative interactive system in accordance with the herein described systems and methods;

FIG. 9 is a flow diagram of the processing performed in an illustrative operation in accordance with the herein described systems and methods;

FIG. 10 is a flow diagram of the processing performed in another illustrative operation in accordance with the herein described systems and methods; and

FIG. 11 is a simulated screen shot of an exemplary computer application incorporating the herein described systems and methods.

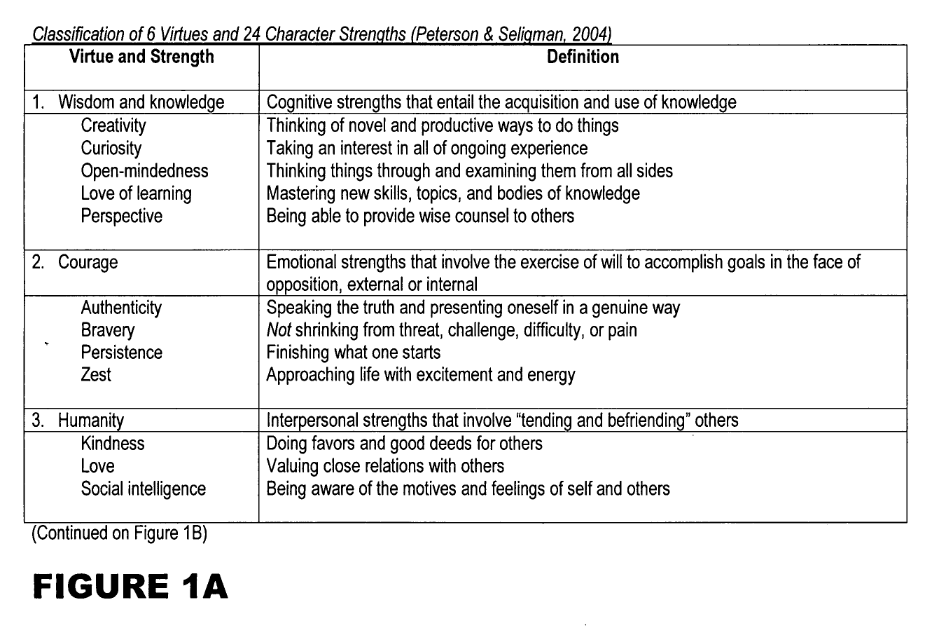

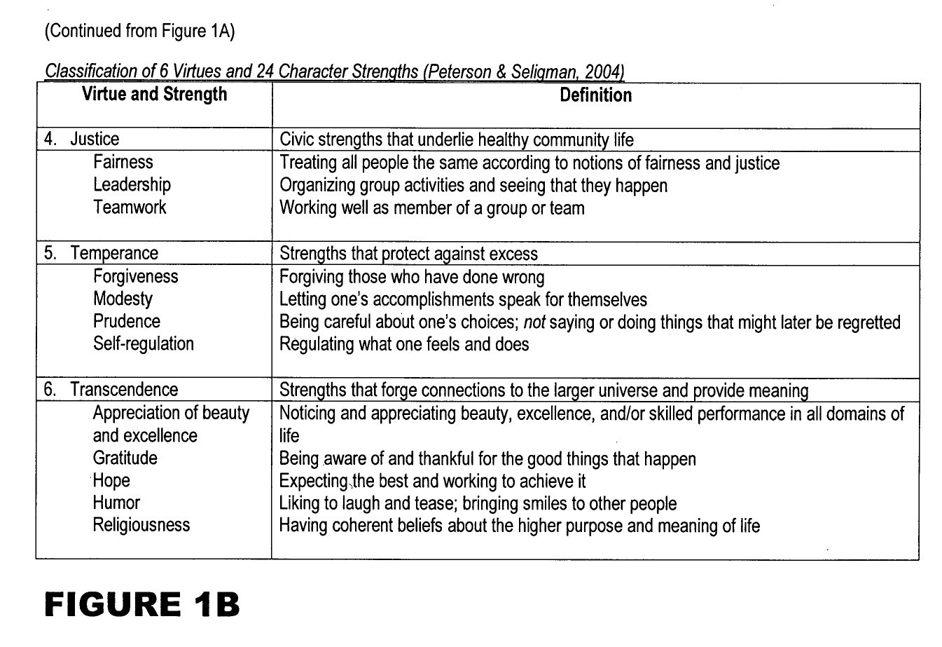

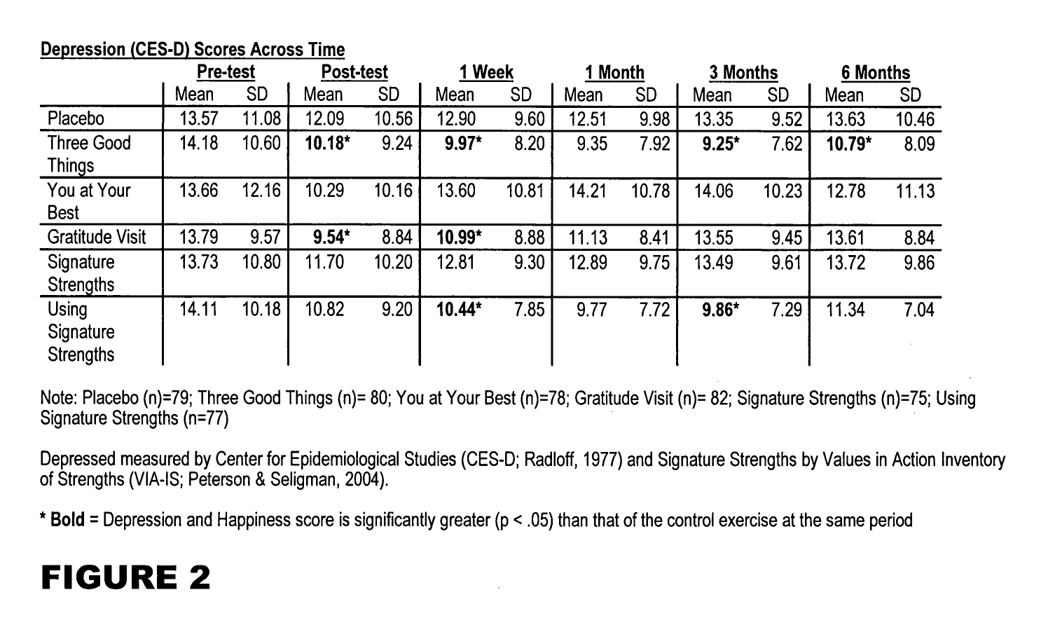

### DETAILED DESCRIPTION

As used herein, the term “mood assessment tool” means an instrument which is used to assess a user's emotional state. Mood assessment tools include tests, questionnaires, surveys, and the like.

As used herein, the term “intervention” means an event designed to positively alter a person's mood, such as to increase happiness or to ameliorate the symptoms of depression. An intervention can include the delivery of an exercise, whether self-directed or facilitated by another; a text exchange, a conversation, or a video conference, whether in real time or delayed; and can include any number of participants. The term “intervention tool” means data or other information which is used in an intervention. Intervention tools include tests, questionnaires, surveys, exercises, and the like, delivered to a person whose mood the intervention is designed to positively alter. Intervention tools and information can be delivered via an electronic platform, such as a computer platform as described herein. The term “PPCT intervention tool” means an intervention tool designed to use principles of positive psychology and/or cognitive therapy (PPCT), as discussed herein.

The term “PPCT partner” means a partner who participates in an intervention which uses a PPCT intervention tool. “PPCT partner content” means instructions and/or other information regarding such an intervention.

The term “signature strength assessment tool” means an instrument which is used to assess a user's strengths, and can include tests, questionnaires, surveys and the like.

Positive Psychology

Positive Psychology has three central concerns: positive experiences, positive individual traits, and positive institutions. Understanding positive emotions entails the study of contentment with the past, happiness in the present, and hope for the future. Understanding positive individual traits consists of the study of the character strengths and virtues: the capacity for love and work, courage, compassion, resilience, creativity, curiosity, integrity, self-knowledge, moderation, self-control, and wisdom. Understanding positive institutions entails the study of the character strengths that foster better communities, such as justice, responsibility, civility, parenting, nurturance, work ethic, leadership, teamwork, purpose, and tolerance.

In practice, positive psychology is an attempt to redress the balance, to encourage psychologists to try to contribute to positive aspects of life, not just do something about negative things. One of its main aims is to produce an “anti-DSM” (DSM—Diagnostic and Statistical Manual of Mental Disorders) of strengths and virtues that are found in the happiest people.

An important feature of positive psychology is its rejection of moral relativism. This is based on the observation that certain character traits and ways of acting are considered good by the vast majority of cultures. It is also observed that these traits lead to increased happiness when practiced. Also important is a distinction between physical pleasure and the gratification of becoming lost in the flow of a task that engages ones abilities.

Positive Psychology Exercises and Relieving Depression

A set of simple positive psychology exercises to increase well-being and show strong and reliable anti depressive effects have been validated in random assignment placebo controlled tests on the web, and in face to face group and individual clinical trials. Findings are as follows.

Student Trials. Initially pilot interventions were developed over the past six years that involved hundreds of participants, ranging from undergraduates to clinically depressed patients. Then five courses were taught involving a total of 200 undergraduates, with weekly assignments to carry out and write up the exercises described hereinafter in their own lives. These seemed remarkably successful.

Training Professionals. In the next phase, over the past two years, the a total of 1000 adults were trained, including at least 500 mental health professionals (including clinical psychologists, life coaches, psychiatrists, and human resources directors) in telephonic virtual courses with 48 hours of instruction over a 6 month period. Each week they were assigned one of the exercises described hereinafter to carry out with their patients and clients. Feedback received from the mental health professionals about the effectiveness of these interventions, particularly with clinically depressed patients, indicated the methods of the invention are remarkably effective.

Random Assignment Controlled Web Studies of Positive Psychology (PP) interventions. Then web-based randomized controlled trials (RCTs) were conducted, the results of which were published (Seligman et al., American Psychologist, July-August 2005.

Over 400,000 people from around the world have registered and responded to questionnaires at www.authentichappiness.org. At a link on the site, some of these individuals went to a research website to help test the interventions. Depression was measured by the Center for Epidemiological Studies Depression (CESD) questionnaire. The CESD is a widely used 20 item questionnaire which indicates the level of depressive symptomatology. Happiness was measured by the Steen Happiness Index (SHI), a 20 item survey designed to indicate one's level of happiness. The items on the SHI reflect three kinds of happiness measures: experiencing and savoring pleasures, losing the self in engaging activities, and participating in meaningful activities.

The participants were then randomly assigned to either a placebo exercise or one of the five interventions described below, and the effectiveness of the interventions in affecting mood was assessed, wherein intervention content was delivered via the internet. All interventions required two to three hours over the course of one week. Following is an abbreviated version of the interventions:

The Gratitude Visit: This intervention required participants to write and present a letter of gratitude to someone they have never properly thanked. Participants received guidance about how to express their gratitude in writing and in person.

Three Blessings: Participants were asked to write down three good things (big or small) that happened during the day every night for one week. Next to each good thing listed, individuals addressed the question, “Why did this good thing happen?”

You at Your Best: Participants were to write about a time when they were at their best. During the week, participants reflected on their story and considered the questions such as, what personal strengths did I display when I was at my best? In what other areas of my life might I use these strengths to my advantage?

Signature Strengths: Participants were asked to take the Values in Action Signature Inventory of Strengths (VIA Signature Strengths) (Peterson & Seligman, 2004), write down their top five strengths, and then “use these strengths more often and in new ways” during the week.

Using Your Signature Strengths: This was an expanded version of Signature Strengths intervention. In addition to learning their top five strengths, participants received detailed instructions about how to use these strengths in new ways. Furthermore, they were asked to use their strengths in new ways every day for one week.

Placebo (Control) Condition: Participants who received this intervention were asked to write down an early memory every night before bed for one week.

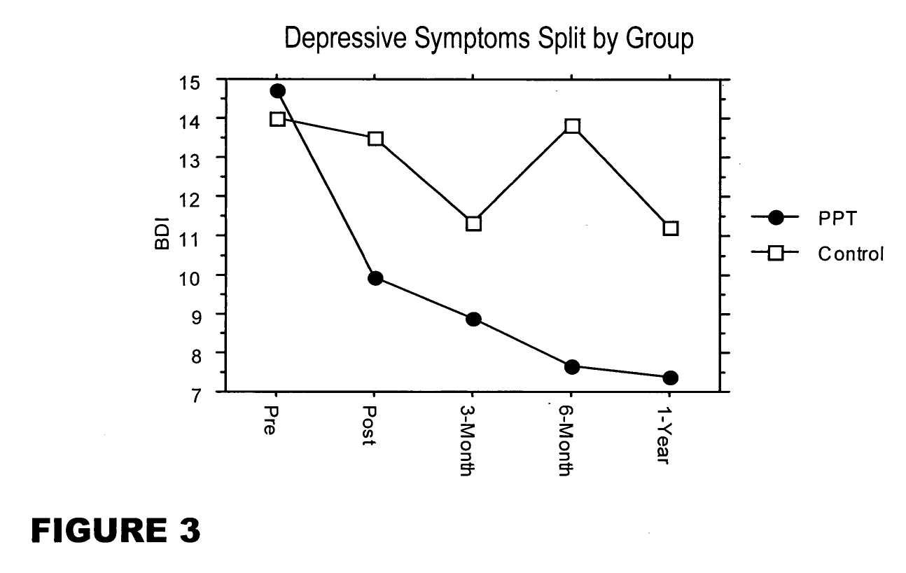

Efficacy of individual exercises. Of the 577 participants who completed the baseline questionnaires, 471 (81.6%) completed all five follow-up assessments. Participants who dropped out of the study did not differ from those who remained on their baseline happiness or depression scores. Included in the analyses were only those participants who completed all follow-up questionnaires. It was found that participants in all conditions (including the control condition) were happier and less depressed at the first follow-up, one week after they received their assigned exercise. After the first follow-up, participants in the control condition were no happier or less depressed than they were at baseline. The scores of participants in the experimental conditions were compared to those of participants in the control condition at the following time points: post-test, 1 week later, 1 month later, 3 months later, and 6 months later. These results are summarized in the table in FIG. 3.

The most important finding was that two of the exercises—the Using Your Signature Strengths exercise and the Three Blessings exercise—decreased depressive symptoms through three to six months, with effect sizes (Cohen's d) of 0.32 and 0.43 respectively. Cohen's d is a measure of the magnitude of a treatment effect. A value of 0.2 indicates a small effect, while 0.5 indicates a medium effect (J. Cohen, 1988, Statistical Power Analysis For The Behavioral Sciences, 2^{nd} ed., Hillsdale, N.J.: Lawrence Earlbaum Associates). These two exercises also increased and sustained happiness level through six months, with an effect size of 0.32 for Three Blessings and 0.40 for the Using Your Signature Strengths exercise. The Gratitude Visit, a third effective exercise, produced strong but short term effects on depression and happiness. Other exercises (including the control exercise) created short-term effects in decreasing depressive symptoms and increasing happiness, but this was fleeting only. Not surprisingly, it was found that the degree to which participants actively continued their assigned exercise beyond the prescribed one-week period mediated the lasting benefits.

Face to Face Positive Interventions with a moderately depressed population. The sample above was subclinical, on average “mild” in depressive symptoms. In a face-to-face random assignment intervention (Parks, Rashid, Rosenstein & Seligman, 2005) the efficacy of a six-week positive intervention was evaluated, consisting of six exercises which increase positive emotion, engagement and meaning, as means of treating depressive symptoms in mild to moderately depressed young adults. When controlling for baseline depressive symptoms, positive intervention decreased depressive symptoms with an effect size of 0.66 and these effects were maintained at three month follow-up. Participants who received the intervention (n=19) scored on average of six points lower on measures of depressive symptoms than a no-intervention control group (n=21) at the end of the intervention. A year later, the Positive Psychology Therapy (PPT) group were still in the non-depressed range, while the controls were still in the mild-moderate symptom range.

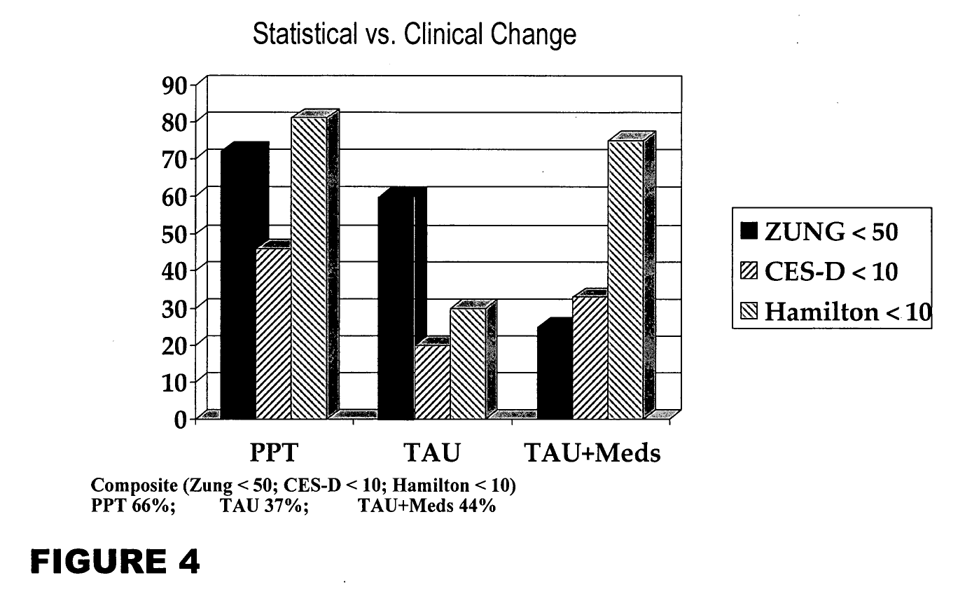

Clinical Trial with Unipolar Depressed Outpatients. In a clinical trial, 29 unipolar depressed patients were randomly assigned to 12 sessions of the Positive Psychology Exercises (n=13) or to Treatment-As-Usual (TAU) (n=16). A matched comparison group (n=17) of TAU plus anti-depressant medication was also recruited from this population. In addition to the CES-D indicator of depression, Zung and Hamilton indicators were also used. See FIG. 4 for a graph comparing the results from the three groups.

It was hoped that the PPT group would do as well as TAU, or as TAU plus medication, but surprisingly the PPT group did better. By the end of treatment, 66% of the PPT group was no longer in the clinical range of depression, whereas only 37% of TAU and 44% of TAU plus medication were out of the clinical range. The various effect sizes approached 1.00.

Reflective Happiness Online Three Blessings Exercise Trials

The results from the Three Blessings exercise indicated that the exercise is effective. Each participant took the CESD depression test, the SHI happiness test, and then each night wrote down three things that went well that day and why they went well. Participants then took the two tests again after the week of recording the three blessings.

A cutoff of over 24 on the CESD was used to label the symptoms of depression in the severe range; 0-9 is roughly in the nondepressed range, below the average for adult Americans; while 10-16 is in the mild range, and 17-24 in the moderate range of depressive symptoms. Fifty subscribers, who did the exercise and took both the pretest and post test, fell into the severe range. They had an average CESD of 33.9, indicating a very depressed state. Most of these people would probably have gotten a diagnosis of depression, had a diagnostic interview been done. Individuals with these symptoms can be truly debilitated, suffering a lot of sadness, crying a lot, very passive, with no zest, major loss of pleasure, and they are usually functioning very poorly, if at all, in work and love.

Their depression scores on average got much better after the three blessings exercise: to 17.2, right at the cusp of mild to moderate symptoms. 47 of the fifty people (94%) decreased in depression.

Their happiness scores, which averaged 53.4 (roughly in the bottom 10%) at pretest, zoomed up to 69.8 on average at post test. This elevated them to the 40th percentile on happiness. 46 of the fifty people (92%) increased in happiness.

These large changes in depression and happiness occurred, moreover, in an average of just 14.8 days from pretest to post test. Since these studies were conducted, the number of participants with severe depression for whom data is available is now well over 400 and the success rate is almost identical to the earlier online studies.

These web-only results are comparable to the effects of medication and psychotherapy. As a rough comparison in a separate study, over four weeks, combined Cognitive Therapy and Medication was found to decrease depressive symptoms (measured by a comparable instrument) from 34.1 to 19.6 (n=134) versus a placebo, which went from 34.8 to 24.4 (n=49).

Taken together these data indicate strong anti-depression effects of a single or better series of exercises. These effects have been demonstrated in mild, moderate, and severe depression, in face-to-face delivery, in individual delivery, in group delivery, in the field, and in random-assignment placebo controlled study. The exercises are efficacious delivered either on the web with no human hands or face-to-face by clinicians. Unlike taking medications or doing therapy as usual, people enjoy these exercises (since they are about strengths and positive emotion) and the drop out rate is low. This exercise is included in PPCT content now offered online through www.reflectivehappiness.com.

System and Method Overview:

The herein described systems and methods aim to ameliorate symptoms of depression and increase happiness in users, whose mood is altered through the use of electronic media. In an illustrative implementation, a computing environment is provided having content (e.g., positive psychology and/or cognitive therapy (PPCT) content) that is communicated to the user through a graphical user interface. This content is interactive and can provide Positive Psychology exercises, along with other content that can be communicated according to a selected mood affecting paradigm, which users can complete to affect their own mood. In the illustrative implementation, the mood affecting paradigm can optionally be combined with other existing mood affecting practices, such as anti-depressants (e.g., either or both prescription or homeopathic anti-depressant medications), to enhance the impact of the other treatments. In this context, the mood affecting paradigm assists to overcome the shortcomings of existing practices (e.g., prescription drugs) by helping to reduce recurrence of undesirable moods (e.g., depression across all levels).

In an illustrative operation, the participating user can complete a number of exercises and comprehend other content as a part of the selected mood affecting paradigm. In this illustrative operation, the computing environment can track a participating user's interaction with the content (e.g., exercises) and provide quantitative and qualitative feedback on the progress of the participating user in their effort to affect their mood. This feedback can also be used to determine the efficacy of the selected mood altering paradigm on a particular participating user or selected demographics of an entire population of participating users.

Illustrative Computing Environment:

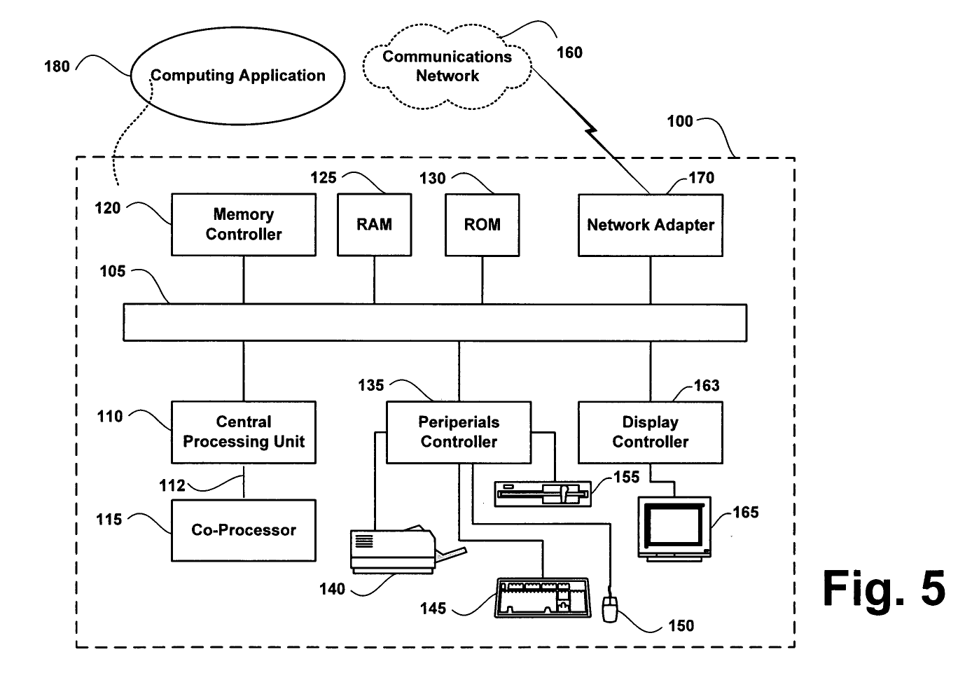

FIG. 5 depicts an exemplary computing system 100 in accordance with herein described system and methods. The computing system 100 is capable of executing a variety of computing applications 180. Computing application 180 can comprise a computing application, a computing applet, a computing program and other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to do work. In many known computer servers, workstations and personal computers CPU 110 is implemented by micro-electronic chips CPUs called microprocessors. A coprocessor 115 is an optional processor, distinct from the main CPU 110 that performs additional functions or assists the CPU 110. The CPU 110 may be connected to co-processor 115 through interconnect 112. One common type of coprocessor is the floating-point coprocessor, also called a numeric or math coprocessor, which is designed to perform numeric calculations faster and better than the general-purpose CPU 110.

In operation, by example, the CPU 110 fetches, decodes, and executes instructions, and transfers information to and from other resources via the computer's main data-transfer path, system bus 105. Such a system bus connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain peripherals controller 135 responsible for communicating instructions from the CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, and video. The display controller 163 includes electronic components required to generate a video signal that is sent to display 165. Further, the computing system 100 can contain network adaptor 170 which may be used to connect the computing system 100 to an external communication network 160.

Illustrative Networked Computing Environment:

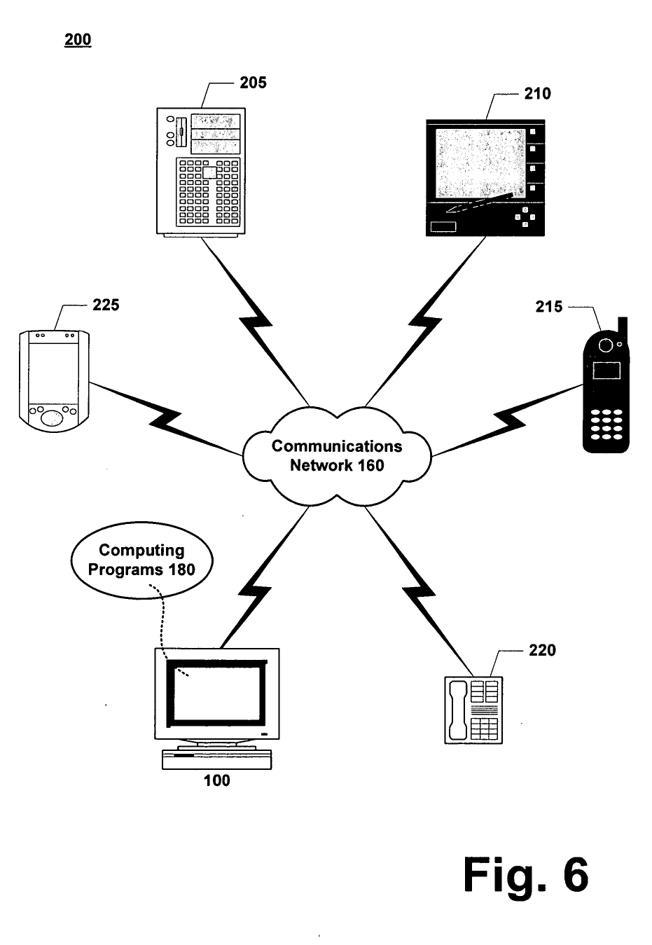

Computing system 100, described above, can be deployed as part of a computer network. In general, the above description for computing environments applies to both server computers and client computers deployed in a network environment. FIG. 6 illustrates an exemplary illustrative networked computing environment 200, with a server in communication with client computers via a communications network, in which the herein described apparatus and methods may be employed. As shown in FIG. 6, server 205 may be interconnected via a communications network 160 (which may be either of, or a combination of a fixed-wire or wireless LAN, WAN, intranet, extranet, peer-to-peer network, the Internet, or other communications network) with a number of client computing environments such as tablet personal computer 210, mobile telephone 215, telephone 220, personal computer 100, and personal digital assistance 225. In a network environment in which the communications network 160 is the Internet, for example, server 205 can be dedicated computing environment servers operable to process and communicate data to and from client computing environments 100, 210, 215, 220, and 225 via any of a number of known protocols, such as, hypertext transfer protocol (HTTP), file transfer protocol (FTP), simple object access protocol (SOAP), or wireless application protocol (WAP). Each client computing environment 100, 210, 215, 220, and 225 can be equipped with browser operating system 180 operable to support one or more computing applications such as a web browser (not shown), or a mobile desktop environment (not shown) to gain access to server computing environment 205. Client computing environments 100, 210, 215, 200, and 225 can operate to execute one or more computing applications and applets operating to process one or more high level computing language (e.g., HTML, JAVA, FLASH Media, etc.).

In operation, by example, a user (not shown) interacts with a computing application running on a client computing environments to obtain desired data and/or computing applications. The data and/or computing applications are stored on server computing environment 205 and communicated to users through client computing environments 100, 210, 215, 220, and 225, over exemplary communications network 160. A user requests access to specific data and applications housed in whole or in part on server computing environment 205. These data are communicated between client computing environments 100, 210, 215, 220, and 225 and server computing environment 205 for processing and storage. Server computing environment 205 hosts computing applications, processes and applets for the generation, authentication, encryption, and communication of web services and can cooperate with other server computing environments (not shown), third party service providers (not shown), network attached storage (NAS), and storage area networks (SANs), to realize such web services transactions.

Affecting Mood Via Electronic Media:

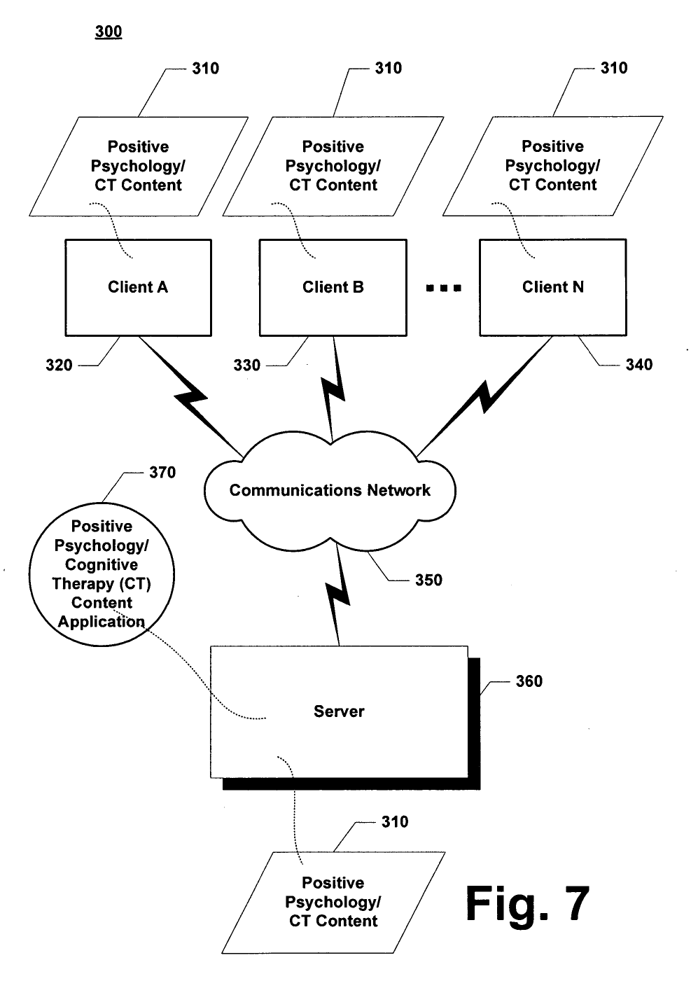

FIG. 7 shows an illustrative implementation of exemplary mood affecting environment 300. As is shown in FIG. 7, exemplary mood affecting environment comprises client computing environment 320, client computing environment 330 up to an including client computing environment 340, communications network 350, server computing environment 360, positive psychology content application 370, and positive psychology content 310.

In an illustrative embodiment, client computing environments 320, 330, and 340 communicate with server computing environment 360 over communications network 350 to provide requests for and receive positive psychology/cognitive therapy (CT) content 310. Positive Psychology/Cognitive Therapy (PPCT) content application 370 operates on server computing environment 360 to provide one or more instructions to server computing environment 360 to process requests for PPCT content 310 and to provide PPCT content 310 to the requesting client computing environment (e.g., client computing environment 320, client computing environment 330, or client computing environment 340). Also, as is shown in FIG. 7, client computing environments 320, 330, and 340 are capable of processing PPCT content 310 for display and interaction to one or more participating users (not shown). In the example, participating users (not shown) interact with positive psychology content application 370 to establish user profiles for use in developing customizable PPCT content programs that can be used to treat and change participating user moods. Further, in the example, positive psychology content application 370 operates to electronically deliver PPCT content 310 according to a selected paradigm (not shown), such that a first selected PPCT content 310 is delivered in a first selected time period T1, a second PPCT content 310 is delivered in a second selected time period T2, and so on as the paradigm instructs.

It is appreciated that although exemplary mood affecting environment 300 of FIG. 7 is shown to provide positive psychology content that such description is merely illustrative as the inventive concepts described herein can extend to the delivery of a combination of content including, but not limited to, positive psychology content, cognitive behavioral therapy content, and other mood altering information. Moreover, it is appreciated that the inventive concepts described herein as affecting mood through the delivery of content can be used exclusively to affect mood, or can be used in combination with other existing mood altering practices such as prescription therapy (e.g., administration of anti-depressants to treat depression).

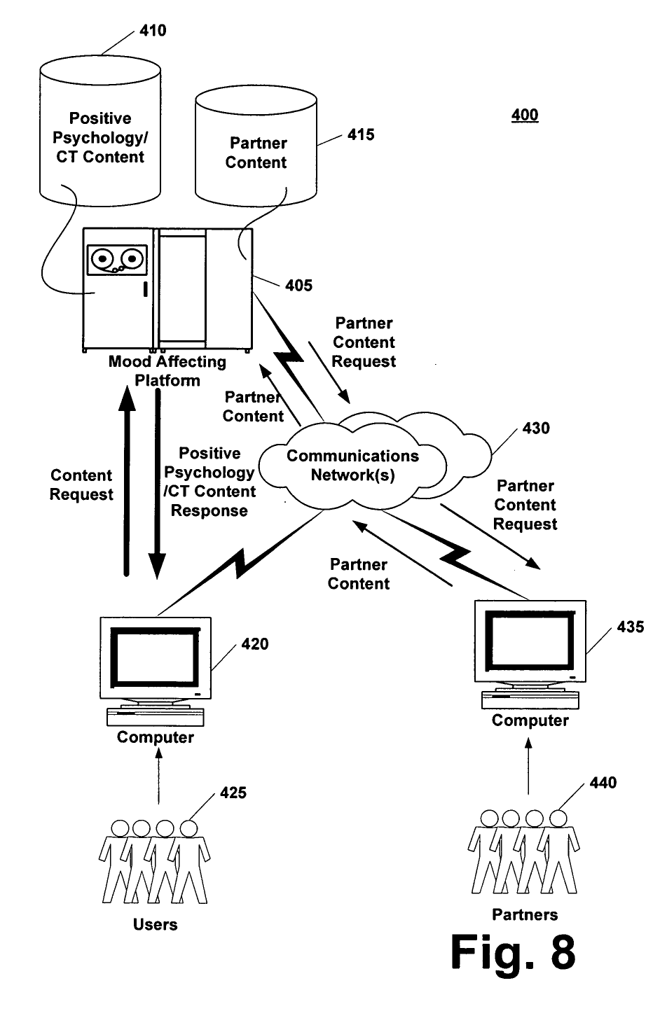

FIG. 8 shows a detailed illustrative implementation of exemplary mood affecting environment 400. As is shown in FIG. 8, exemplary mood affecting environment 400 comprises mood affecting platform 405, PPCT content data store 410, partner content data store 415, communications network 430, computer environment 420, users 425, partner computing environment 435, and partners 440.

In an illustrative embodiment, mood affecting platform 405 is electronically coupled to computing environment 420 and computing environment 435 via communications network 430. In the illustrative implementation, communications networks can comprise fixed-wire and/or wireless intranets, extranets, and Internet.

In another illustrative operation, users 425 interact with a computing application (not shown) operating on computing environment 420 to provide requests for positive psychology content that are passed across communications network 430 to mood affecting platform 405. In addition to requests for positive psychology content, users 425 interact with the exemplary computing application (not shown) to provide user profile information that are used by the exemplary computing application to customize positive psychology content for each participating user individually. Also, the exemplary computing application operates to provide customized PPCT content based on a selected paradigm such that participating users can receive portions (one or more) of PPCT content on a selected temporal basis. In the illustrative operation, mood affecting platform 405 processes requests for PPCT content and retrieves PPCT content from PPCT data store 410. Additionally, as part of processing, mood affecting platform 405 identifies if there is any partner content that is to be associated to the retrieved positive psychology content retrieved from PPCT content data store 410. If there is associated partner content, mood affecting platform 405 operates to retrieve partner content from partner content data store 415 as part of processing the described requests.

In the illustrative operation, responsive to the requests from users 425 for PPCT content, mood affecting platform 405 assembles PPCT content and partner content for communication to users through communications network 430. The retrieved PPCT and/or partner content is then displayed on computing environment 420 for interaction by users 425. If users interact with the PPCT and/or partner content, computing application (not shown) operating on computing environment 420 cooperates with mood affecting platform 405 to retrieve additional PPCT and/or partner content from positive psychology content data store 410 and/or partner content/CT data store 410.

Also as is shown in the illustrative operation, mood affecting platform 405 cooperates with partner computing environment 435 and partners using partner computing environment 435 to obtain partner content as part of processing requests for positive psychology content. The cooperation between mood affecting platform 405 can be passive and/or active such that in the passive context partner content can be obtained prior to processing requests and stored in partner content data store 415 (e.g., multimedia files—video/audio, electronic documents, presentations, etc.). In the active context, mood affecting platform 405 cooperates with partner computing environment 435 to obtain partner content in real time from partners (e.g., online chat, instant messaging, web streaming, video conferencing, etc.) as part of processing requests for PPCT content.

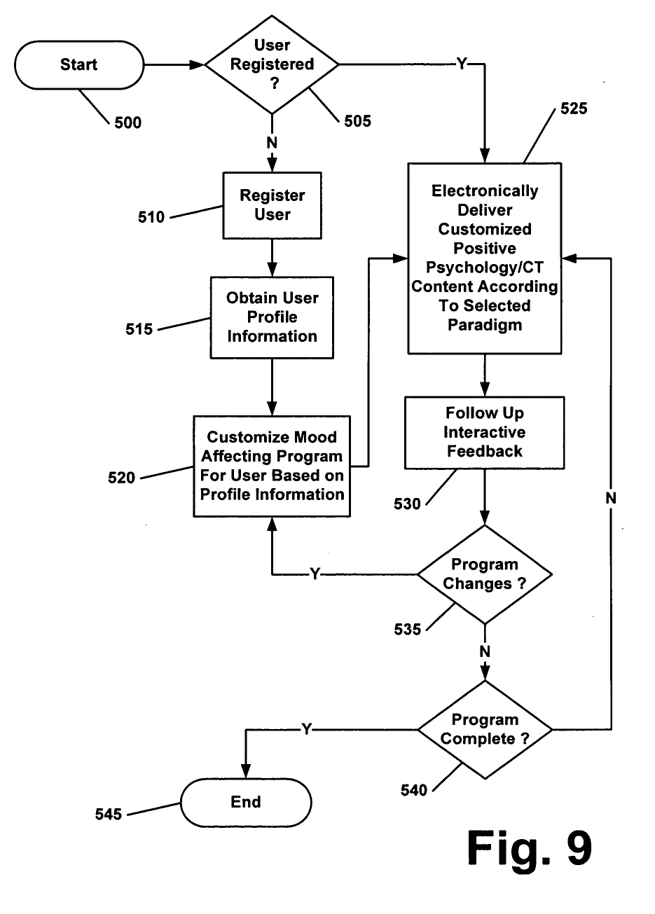

FIG. 9 shows exemplary processing performed by an illustrative implementation of exemplary mood affecting environment 400 of FIG. 8. As is shown, processing begins at block 500 and proceeds to block 505, where a check is performed to determine if the participating user is registered to use the mood affecting platform (not shown). If the check at block 505 indicates that the user is not registered, processing proceeds to block 510 where the participating user registers. From there, processing proceeds to block 515, where profile information about the user is obtained. Included in the user profile information can be information indicative of the user's state of happiness as effected through receiving answers to one or more questionnaires. Also, the user's mood history can be collected during the processing at block 515. Processing then proceeds to block 520, where a customized mood affecting program is developed for the user based on the collected user profile information. Processing then proceeds to block 525, where customized PPCT content is electronically delivered to the participating user according to a selected paradigm. In an illustrative operation, the selected paradigm can have instructions on the frequency of the delivery (e.g., once a week for 12 weeks) of PPCT content and the nature of the PPCT content (e.g., newsletter and recommended reading lists). A follow up interactive feedback is then performed at block 530. The follow up interactive feedback processing can include providing questionnaires (e.g., self-assessment questionnaires) to participating users (e.g., before and after exercises) to determine the efficacy of the delivered PPCT content (that is delivered at block 525). A check is then performed at block 535 to determine if changes to the program are needed based on the results of the interactive feedback. If changes are needed, processing reverts to block 520 and proceeds from there.

However, if the check at the block 535 indicates that changes are not needed, processing proceeds to block 540, where a check is performed to determine if the program has been completed (e.g., has the user reached selected goals—user's mood has been adequately affected). If the check at block 540 indicates that the program is completed, processing proceeds then terminates at block 545. However, if the check at block 540 indicates that the program has not been completed, processing reverts to block 525 and proceeds from there. Also, if the check at block 505 indicates that the user is registered, processing proceeds to block 525 and proceeds from there.

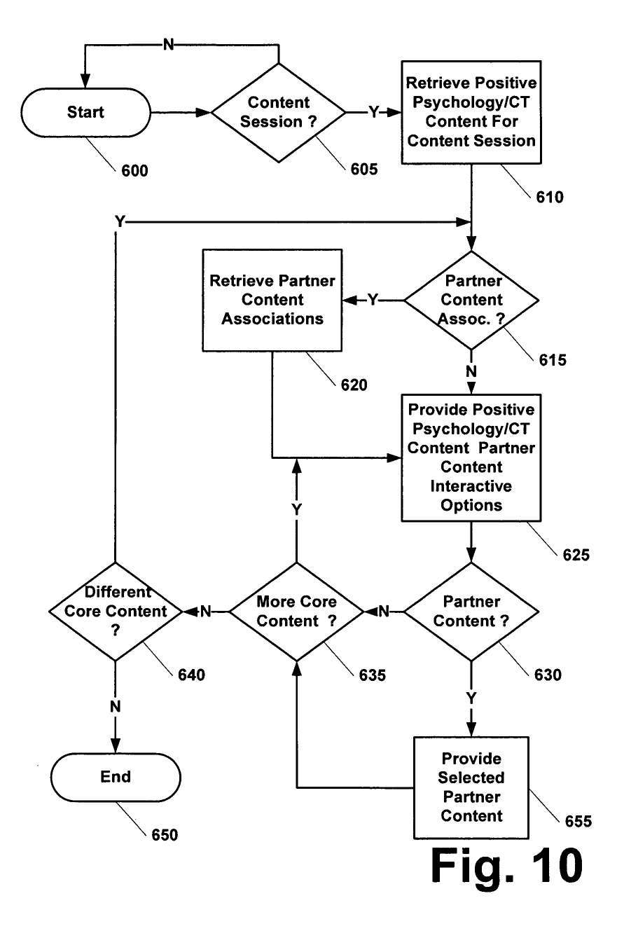

FIG. 10 shows another exemplary processing performed by an illustrative implementation of exemplary mood affecting environment 400 of FIG. 8. As is shown, processing begins at block 600 and proceeds to block 605, where a check is performed to determine if a content session has been established. If the check at block 605 indicates that a content session has not been established, processing reverts back to block 600 and proceeds from there. However, if at block 605 the check indicates that a content session has been established, processing proceeds to block 610 where PPCT content for the content session is retrieved. A check is then performed at block 615 to determine if there are any partner content associations with the retrieved PPCT content. If the check at block 615 indicates that there are one or more partner content associations, processing proceeds to block 620 where the partner content associations are retrieved. Conversely, if at block 615 the check indicates that there are no partner content associations for the retrieved PPCT content, processing proceeds to block 625 and proceeds from there.

From block 615, processing proceeds to block 625, where the retrieved original PPCT content along with the identified partner content is provided to the end user such that the PPCT and/or partner content contains interactive mechanisms to allow participating users to select PPCT and/or partner content. A check is then performed at block 630 to determine if one or more partner content (i.e., associated to the positive psychology content) has been selected by a participating end-user. If the check at block 630 determines that partner content has been selected, processing proceeds to block 645, where the selected partner content is provided to the participating end-user (e.g., live interactive media presentation by a selected partner having information related to one or more subjects pertaining to the retrieved positive psychology content). Conversely, if the check at block 630 indicates that partner content has not been selected processing proceeds to block 635. From block 630 processing proceeds to block 635 where a check is performed to determine if a participating end-user has selected to interact with some of the initially retrieved PPCT content. If the check at block 635 determines that additional originally selected PPCT content has been selected by the participating end-user, processing proceeds to block 625 and proceeds from there.

If, however, the check at block at 635 indicates that more of the originally retrieved PPCT content has not been selected, processing proceeds to block 640, where a check is performed to determine if new PPCT content has been selected. If the check at block 640 indicates that new original PPCT content has been selected, processing reverts to block 615 and proceeds from there. However, if at block 640 it is determined that new PPCT content has not been selected, processing proceeds to block 650 and terminates.

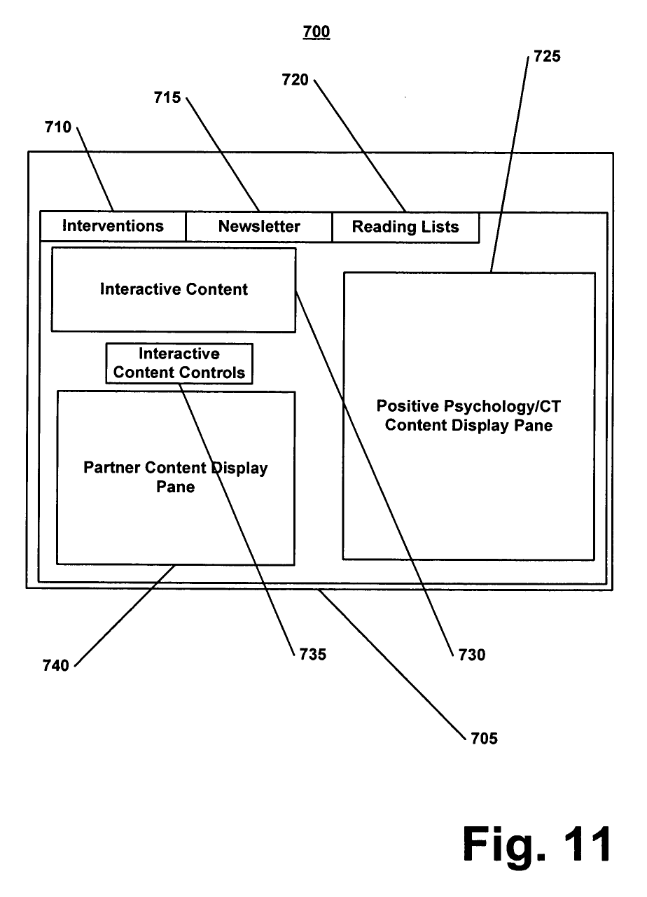

FIG. 11 shows an exemplary screen shot of exemplary PPCT content application 370 of FIG. 7. As is shown, an exemplary positive psychology content application comprises computing environment 700 that further comprises graphical user interface (GUI) 705. GUI 705 comprises navigation buttons 710, 715, and 720, interactive content display pane 730 having interactive content controls 735, partner content display pane 740, and positive psychology content display pane 725.

In an illustrative operation, a participating user (not shown) interacts with navigation buttons 710, 715, or 720 found in GUI 705 to select specific mood affecting content such as interventions 710, newsletters 715, and reading lists 725. Depending on the content chosen, one or more display panes 725, 730, and/or 740 can be populated with content for use as part of a mood affecting program. In the case interactive content is populated in interactive content display pane 730, participating users (not shown) can also be provided interactive content controls 735 for us to navigate and control interactive content found in interactive content display pane 735. In an illustrative implementation, the interactive content comprises a complete reflective happiness program or one or more selected exercises from such an exemplary program.

In another illustrative implementation, interactive content display pane 730 consists of multimedia content (e.g., a video) which the user controls using interactive content controls 735. In the illustrative implementation, partner content display pane 740 is used to display partner content that can be associated to PPCT content that is displayable in positive psychology content display pane 725. As such, computing environment 700 offers participating users a dynamic, robust, and interactive environment in which PPCT, partner, and/or interactive content can be displayed and manipulated as part of a mood affecting program. In the illustrative implementation, the computing environment can operate to process high level languages for use in displaying and interaction of the content including, but not limited to, HTML, JAVA, and MACROMEDIA® FLASH computing languages.

It is appreciated that although exemplary computing environment 700 is described to contain various components in specific configurations, such description is merely illustrative as the inventive concepts described herein can extend to various computing environments having various components having various configurations.

Description of Mood Assessing Tools

Mood assessment tools delivered in accordance with the invention can include one or more of the following.

Authentic Happiness Inventory (AHI)—measures overall happiness.

CESD Questionnaire—measure symptoms of depression.

Seligman Attributional Style Questionnaire (SASQ)—measures attributional style.

Fordyce emotions questionnaire—measures current happiness.

General happiness scale—assesses enduring happiness.

Panas Questionnaire—measures positive and negative affect.

The Gratitude Survey—measures appreciation about the past.

Optimism Test—measures optimism about the future.

Transgression Motivations Questionnaire—measures forgiveness.

Work-Life Questionnaire—measures work-life satisfaction.

Close Relationships Questionnaire—measures attachment.

Meaning In Life Questionnaire—measures meaningfulness.

Approaches To Happiness Questionnaire—measures three routes to happiness.

Satisfaction With Life Scale—measures life satisfaction.

Description of Signature Strength Assessing Tools

Signature strength assessment tools delivered in accordance with the invention can include one or more of the following.

VIA Signature Strengths Survey—measures 24 character strengths.

Brief Strengths Test—measures character strengths.

The Grit Survey—measures the character strength of perseverance.

Description of Positive Psychology Exercises

Interventions delivered in accordance with the invention can include one or more of the following positive psychology exercises.

Three Blessings—This happiness building exercise is designed to increase the user's life satisfaction and to sweeten memories about the past. It has been determined in well designed research studies that becoming much more conscious of good events reliably increases happiness and decreases depression.

Gratitude Visit—This exercise is a powerful tool for increasing life satisfaction because it amplifies good memories about the past, and it forges a very strong bond with an important person from the user's past. The goal of this exercise is for the user to experience the power of expressing gratitude to someone who has touched the user's life.

Savor a Beautiful Day—This exercise is about the user taking time out to appreciate and indulge in the things in life which gives the user pleasure. This is a fun and important step to achieving happiness. The goal of the Savor a Beautiful Day™ exercise is to increase awareness of pleasure, to make it last, and to make it more intense.

Active & Constructive Responding—This exercise is intended to build the user's ability to respond actively and constructively to positive events reported by others.

Positive Service—The Positive Service: a Path to More Meaning to Life™ exercise purpose is to increase the amount of meaning in the user's life. Meaning consists of being attached to something that is believed to be larger than the self.

VIA Signature Strengths—This exercise is designed to encourage the user to identify and own signature strengths by finding new and/or more frequent uses for them. As challenging situations arise in life, the user is taught to ask how signature strengths could be applied to improve or make the most of the situation.

The Strengths Date—This is a fun exercise for the user and a partner (friend, spouse, child, parent, teacher, colleague) to experience together. It includes designating time together and calls on the signature strengths of both individuals. It is based on the VIA Strengths Survey.

Knitting the Strengths Fabric of Friendship—This exercise is designed to encourage good friends to better recognize each other's strengths.

Good Consumerism—This exercise presents the user with alternatives to “purchasing positive emotion” in the form of expensive presents which do not produce lasting happiness. This exercise is designed to increase engagement and meaning to the user's life.

Letting Go of Grudges—Designed to create more positivity in the user's life. It uses gratitude to loosen the user's grip on a grudge. The goal of the exercise is to see the other person, against whom the user has held a grudge, in their entirety and to remember and record as many things as possible for which the user is grateful to them.

Honey vs. Vinegar Week—Research indicates a person, on average, is thwarted about twice a day. In accordance with this exercise, when this happens, flip a coin. Heads, it's honey. Tails, it's vinegar. If heads, slow down and try to be understanding. If tails, express your frustration. Keep track of what happens.

Being a Good Teammate—The self-improvement shelves carry dozens of books on “leadership.” Teaching leadership is the thing to do in schools of business, in the military, and in politics. Followership, on the other hand, is a natural class and it is relatively homogeneous across domains. We call it being a good citizen, having loyalty, and being a good teammate. In this age in which everyone is supposed to be a leader, it is also even more true that everyone needs to learn to be a good follower. And being a good teammate is teachable. This exercise is designed to teach good followership skills.

Scanning for Three Blessings—This exercise is designed to re-educate the user's attention to the positives in just the same way as the Three Blessings exercise re-educates memory. This exercise can be done in conjunction with the Three Blessings.

Description of Cognitive Therapy Exercises

Interventions delivered in accordance with the invention also include one or more of the following cognitive therapy exercises.

What Door Opened?—This exercise is designed to build hope and optimism. Hope and optimism are positive emotions about the future. It has been very well-documented that increasing these emotions decreases depression, increases performance at work and sports, and increases physical health. The first step in learning optimism is to realize that every time a door closes, another door opens.

ABCDE Disputation—This exercise is designed to build optimism. Pessimistic explanations for good events stop individuals from getting on a roll and taking full advantage of victory. This exercise shows how to dispute temporary, specific (and external) explanations for success and change them into permanent, pervasive (and personal) explanations—the explanations needed to keep successes coming.

Rapid Fire Disputing—This exercise is designed to build optimism. In this exercise, the user is taught to dispute negative thoughts on the fly. Being able to challenge pessimistic thoughts in real time is a very powerful skill in maintaining a happy mindset for the long-term.

In an embodiment, recent research indicates that the use of multiple positive psychology/cognitive therapy exercises in combination yields additive effects, being more effective than the use of a single exercise alone. The present invention facilitates the delivery of multiple PPCT exercises.

Other Supporting Information and Content

In addition to the disclosed mood and signature strength assessing tools and positive psychology and cognitive therapy exercises, delivered content can comprise other positive psychology and/or cognitive therapy information and content including, but not limited to, Tests & Questionnaires, Reflective Happiness Newsletters, Q&A with Positive Psychology Experts, Positive Psychology Book Club, Happiness Tips, At the Movies, Global Perspective on Positive Psychology, Positive Psychology Links, Positive Psychology Research, Positive Psychology Conference Schedules, and Positive Psychology in the News.

Enhancing Conventional Drug Therapy

Recent research indicates the efficacy of drug therapy is enhanced when used in conjunction with the positive psychology therapy (PPT), such as the delivery of PPCT content as in the present invention. There are at least three ways in which the use of PPT in conjunction with drug therapy can enhance the therapeutic effects of the drug therapy. First, the use of PPT in conjunction with drug therapy can accelerate the onset of the anti-depressant effects of the drug therapy. Second, the effectiveness of the drug therapy is improved, yielding a better effect from the same amount of drug. Third, drugs alone do not reduce the recurrence of symptoms of depression. However, when drug therapy is used in conjunction with PPT, the recurrence of symptoms of depression is reduced.

It is understood that the herein described systems and methods are susceptible to various modifications and alternative constructions. There is no intention to limit the invention to the specific constructions described herein. On the contrary, the invention is intended to cover all modifications, alternative constructions, and equivalents falling within the scope and spirit of the invention.

It should also be noted that the present invention may be implemented in a variety of computer environments (including both non-wireless and wireless computer environments), partial computing environments, and real world environments. The various techniques described herein may be implemented in hardware or software, or a combination of both. The techniques may be implemented in computing environments maintaining programmable computers that include a processor, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

The disclosures of each patent, patent application and publication cited or described in this document are hereby incorporated herein by reference, in their entirety.

While the foregoing specification has been described with regard to certain preferred embodiments, and many details have been set forth for the purpose of illustration, it will be apparent to those skilled in the art without departing from the spirit and scope of the invention, that the invention may be subject to various modifications and additional embodiments, and that certain of the details described herein can be varied considerably without departing from the basic principles of the invention. Such modifications and additional embodiments are also intended to fall within the scope of the appended claims.

What is claimed is:

1. A system for positively changing a mood of a user through electronic media comprising:
mood assessment data storage for storing at least one mood assessment tool;
positive psychology/cognitive therapy (PPCT) data storage for storing at least one PPCT intervention tool; and
a delivery platform, comprising:
an interactive graphical user interface (GUI) for the user to select, receive and submit responses to mood assessment tools and PPCT intervention tools; and
a mood determining function for determining a mood of the user based on at least one mood assessment tool response.

2. The system of claim 1, further comprising:
PPCT partner data storage for storing PPCT partner information and associated PPCT partner content; and
the delivery platform further comprising:
at least one instruction set associating the PPCT partner content with a selected PPCT intervention tool; and
the GUI for the user to receive the associated PPCT partner content.

3. The system of claim 2, further comprising the GUI for the user to select a PPCT partner and to receive the associated PPCT partner content.

4. The system of claim 1, further comprising:
signature strength data storage for storing at least one signature strength assessment tool; and
the delivery platform further comprising:
the GUI for the user to select, receive and submit responses to at least one of the signature strength assessment tools; and
a signature strength determining function for determining at least one signature strength of the user based on at least one of the signature strength assessment tool responses.

5. The system of claim 4, wherein the at least one signature strength assessment tool comprises at least one of VIA Signature Strengths Survey, Brief Strengths Test, and The Grit Survey.

6. The system of claim 1, wherein the delivery platform comprises a networked computing environment.

7. The system of claim 1, wherein the at least one mood assessment tool comprises at least one of Authentic Happiness Inventory (AHI), CESD Questionnaire, and Seligman Attributional Style Questionnaire (SASQ).

8. The system of claim 1, wherein the at least one PPCT intervention tool comprises at least one of Three Blessings, Gratitude Visit, Savor a Beautiful Day, Active & Constructive Responding, Positive Service, What Door Opened?, ABCDE Disputation, Rapid Fire Disputing, VIA Signature Strengths, The Strengths Date, Knitting the Strengths Fabric of Friendship, Good Consumerism, Letting Go of Grudges, Honey vs. Vinegar Week, Being a Good Teammate, and Scanning for Three Blessings.

9. A method for positively changing a mood of a user using electronic media, the method comprising:
providing to the user a user-selected mood assessment tool using an interactive graphical user interface (GUI);
receiving the user's mood assessment responses;
determining the mood of the user based on the mood assessment responses;
presenting to the user via the GUI at least one positive psychology/cognitive therapy (PPCT) intervention tool based on the determined mood of the user; and
providing to the user a user-selected PPCT intervention tool;
whereby the user interacts with the provided PPCT intervention tool, effecting a positive change to the mood of the user.

10. The method of claim 9, further comprising:
providing a PPCT partner and associated PPCT partner content; and
delivering to the user the PPCT partner content.

11. The method of claim 10, wherein the PPCT partner is selected by the user from a plurality of candidate PPCT partners.

12. The method of claim 11, wherein a plurality of icons is provided on the GUI, wherein each icon corresponds to a candidate PPCT partner, and the user selects the PPCT partner from the candidate PPCT partners by choosing the icon corresponding to the PPCT partner.

13. The method of claim 9, further comprising:
providing to the user a user-selected signature strength assessment tool;
receiving the user's signature strength assessment responses;
determining at least one signature strength of the user based on the signature strength assessment responses; and
providing to the user the PPCT intervention tool based at least in part on the determined user signature strengths.

14. The method of claim 9, further comprising:
receiving user feedback regarding the changes produced in the mood of the user; and
providing the PPCT intervention tool based at least in part on the feedback.

15. The method of claim 14, further comprising;
periodically receiving user-selected mood assessment tool responses; and
using the periodic mood assessment tool responses to track changes in the user's mood.

16. The method of claim 15, further comprising:
determining a user profile from the periodic mood assessment tool responses; and
providing the PPCT intervention tool based at least in part on the user profile.

17. A computer-implemented interactive method for receiving a PPCT intervention tool, comprising:
selecting and receiving, via a graphical user interface (GUI), a mood assessment tool, and submitting responses to the mood assessment tool; and
selecting and receiving, via the GUI, a PPCT intervention tool from among one or more PPCT intervention tools.

18. The method of claim 17, further comprising receiving, via the GUI, PPCT partner content associated with the selected PPCT intervention tool.

19. The method of claim 17, further comprising using the PPCT intervention tool in conjunction with drug therapy.

20. The method of claim 19, further comprising using the PPCT content to enhance the efficacy of the drug therapy.
